(19) United States
(12) Patent Application Publication
(10) Pub. No.: US 2006/0139751 A1
(43) Pub. Date: Jun. 29, 2006

(54) 3-D image display device

(76) Inventors: Kyung-hoon Cha, Yongin-si (KR); Kun-ho Cho, Suwon-si (KR); Dae-sik Kim, Suwon-si (KR); Tae-hee Kim, Suwon-si (KR); Sung-yong Jung, Suwon-si (KR)

Correspondence Address: STANZIONE & KIM, LLP, 919 18TH STREET, N.W., SUITE 440, WASHINGTON, DC, 20006, US

(21) Appl. No.: 11/262,712

(22) Filed: Nov. 1, 2005

(30) Foreign Application Priority Data
Dec. 29, 2004 (KR) 2004-115031

(51) Int. Cl. G02B 27/26

(52) U.S. Cl. 359/465

(57) ABSTRACT

An image display device to display both a 2-D image and a 3-D image. The image display device includes a display element, an image separation unit, a polarization conversion switch, and a birefringence element. The display element emits light according to image information for a left eye and image information for a right eye. The image separation unit separates the emitted light into an image for the left eye and an image for the right eye. The polarization conversion switch sequentially switches the polarization direction of the incident light. The birefringence element transmits or refracts the light, depending on the polarization direction of the light that has passed through the polarization conversion switch. An image, whose polarization direction has been switched by the polarization conversion switch, is shifted when passing through the birefringence element, whereby the left eye image and the right eye image resolution is improved. The polarization direction of incident light is sequentially switched by the polarization conversion switch, and the image, whose polarization direction is switched, is shifted by the birefringence element, so that the resolution of a 3-D image is improved.

### CROSS-REFERENCE TO RELATED APPLICATIONS

This application claims the benefit under 35 U.S.C. §119 from Korean Patent Application No. 2004-115031, filed on Dec. 29, 2004, in the Korean Intellectual Property Office, the disclosure of which is incorporated herein in its entirety by reference.

### BACKGROUND OF THE INVENTION

1. Field of the Invention

The present general inventive concept relates to an image display device for both 2-dimension (2-D) and 3-dimension (3-D) images, and more particularly, to a glassless 3-D image display device capable of switching between a 2-D image and a 3-D image and improving the resolution of a 3-D image.

2. Description of the Related Art

Generally, a 3-D image is realized using the principle of stereo visual sense through two human eyes. A binocular parallax, which occurs because left and right eyes are located about 65 mm apart from each other, is the most important factor producing a cubic effect. A 3-D image display may be a display using glasses or a glassless display. The glassless display obtains a 3-D image by separating left/right images without using glasses. The glassless displays may be classified into a parallax barrier type display and a lenticular type display.

The parallax barrier type display alternately prints images that should be seen respectively by the left and right eyes in the form of a vertical pattern or a photo (in order to see the printed image using an extremely thin vertical lattice column, i.e., a barrier). By doing so, a vertical pattern image that is to be provided to the left eye and a vertical pattern image that is to be provided to the right eye are distributed by the barrier, and images at different viewpoints are seen by the left and the right eyes, respectively, whereby a stereo image is perceived.

According to the parallax barrier type display, referring to FIG. 1A, a parallax barrier 10 having a vertical-lattice-shaped opening 5 and a mask 7 is disposed in front of a liquid crystal (LC) panel 3 having left-eye-image information L and right-eye-image information R that respectively correspond to a left eye (LE) and a right eye (RE) of an observer. An image is separated through the opening 5 of the parallax barrier 10. Image information L that is to be provided to the LE and image information R that is to be provided to the RE are alternately arranged along a horizontal direction on the LC panel 3.

For example, a pixel having the image information L and a pixel having the image information R constitute one set, and pixels on the left and the right of the opening 5 become pixels at different view points, so that a stereo image can be realized. For example, a first left-eye image is provided to a left eye and a first right-eye image is provided to a right eye, and a second left-eye image and a second right-eye image are provided to the left eye and the right eye, respectively. Other pixels on the left and the right of the openings are provided to the corresponding left and right eyes in the same manner.

According to such a method, since images are formed through the opening 5 and blocked by the mask 7, respectively, the image information L is formed, e.g., at even-numbered lines only and is blocked by the mask 7 so that black lines K are formed at odd-numbered lines as illustrated in FIG. 1B. Similarly, the image information R is formed, e.g., at odd-numbered lines only and is blocked by the mask 7 so that the black lines K are formed at even-numbered lines.

Therefore, the resolution of a display on the whole, as well as the brightness of a 3-D image, deteriorates.

### SUMMARY OF THE INVENTION

The present general inventive concept provides an image display device improving the resolution of a 3-D image and capable of producing both 2-D and 3-D images.

Additional aspects and advantages of the present general inventive concept will be set forth in part in the description which follows and, in part, will be obvious from the description, or may be learned by practice of the general inventive concept.

The foregoing and/or other aspects of the present general inventive concept are achieved by providing an image display device, which includes a display element to emit light according to image information for a left eye and image information for a right eye, an image separation unit to separate the emitted light into a left image and a right image corresponding to the image information for the left eye and the image information for the right eye, a polarization conversion switch to sequentially switch a polarization direction of the incident light, and a birefringence element to transmit or to refract the light, depending on the polarization direction of the light that has passed through the polarization conversion switch. Resolution is improved by shifting the image (whose polarization direction has been switched by the polarization conversion switch) using the birefringence element.

The birefringence element may be made of calcite or nematic liquid crystal.

The image separation unit may be a lenticular lens, a fly-eye lens array, or a parallax barrier.

The display element may be a liquid crystal display (LCD) or a ferro LCD.

The polarization conversion switch may be a liquid crystal polarization conversion switch.

The polarization conversion switch may operate with a frequency substantially same as a frequency of an image signal supplied to the display element to update the image information for the left eye and the image information for the right eye.

The display element may be a movable mirror device and include a polarization converter to convert emitted light into one of P polarization and S polarization. The polarization converter may be disposed between the display element and the image separation unit, or between the image separation unit and the polarization conversion switch.

The image information for the left eye and the image information for the right eye may be the same manner so that a 2-D image may be formed.

The foregoing and other aspects of the present general inventive concept may also be achieved by providing a display device to form a first image at a first location and a second image at a second location, the device including a display element to emit polarized light according to an input image signal, an image separation unit to direct the emitted light to form the first image at the first location and the second image at the second location, a polarization conversion switch having an on-state to switch a polarization direction of the light passing through and an off-state to leave the polarization direction of the light passing through unchanged, and a shifting element to transmit the light at different angles depending on the polarization direction of the light.

The foregoing and other aspects of the present general inventive concept may also be achieved by providing a method of forming a first image at a first location and a second image at a second location, the method including emitting polarized light according to an input image signal, directing the emitted light to form the first image at the first location and the second image at the second location, switching a polarization direction of the light, and shifting the light at different angles depending on the polarization direction of the light.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1A is a schematic view of a conventional 3-D image display device based on a parallax-barrier display;

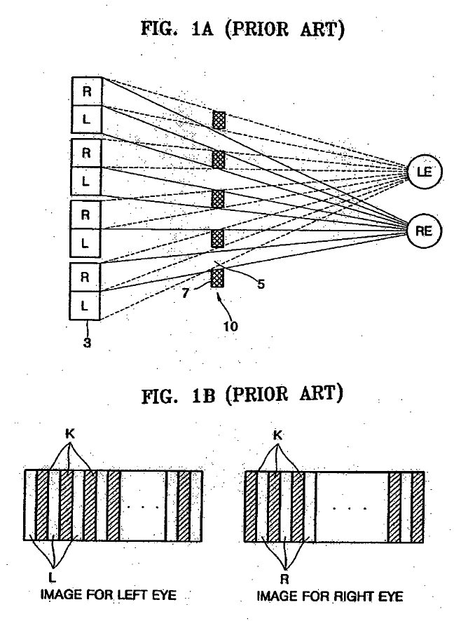

FIG. 1B is a view illustrating an image for a right eye and an image for a left eye, displayed by the 3-D image display device illustrated in FIG. 1A;

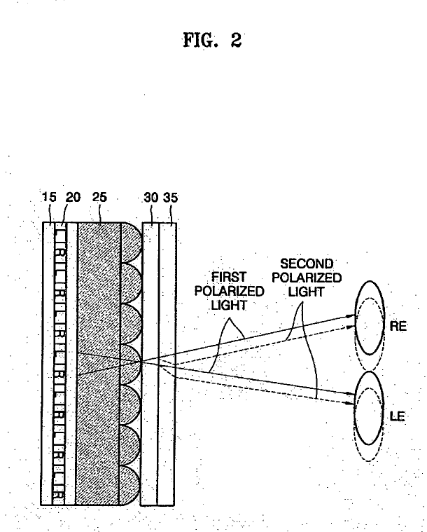

FIG. 2 is a view illustrating a 3-D image display device according to an embodiment of the present general inventive concept;

FIGS. 3A and 3B are views illustrating an image for a right eye and an image for a left eye, displayed by a 3-D image display device of FIG. 2;

FIG. 4 is a view illustrating a pixel image formed by a 3-D image display device of FIG. 2;

FIG. 5 is a view illustrating a construction of a 3-D image display device according to another embodiment of the present general inventive concept;

FIGS. 6A, 6B, 7A, and 7B are views illustrating a method of realizing a 2-D image with the 3-D image display device according to an embodiment of the present general inventive concept; and

FIG. 8 is a view illustrating a 3-D image display device according to another embodiment of the present general inventive concept.

### DETAILED DESCRIPTION OF THE PREFERRED EMBODIMENTS

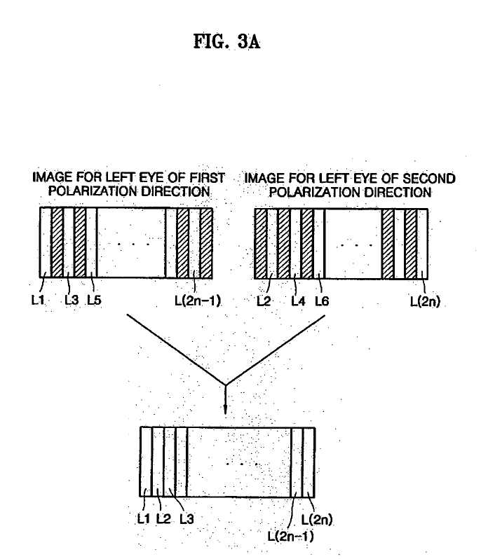

The present general inventive concept will now be described more fully with reference to the accompanying drawings, in which exemplary embodiments of the general inventive concept are shown. Referring to FIG. 2, a display device according to an embodiment of the present general inventive concept includes a light source 15, a display element 20 to emit light according to image information, an image separation unit 25 to separate an image for a left eye and an image for a right eye from the image information of the display element 20 using different optical paths, a polarization conversion switch 30 to selectively switch the polarization direction of incident light, and a birefringence element 35.

The display element 20 can emit light according to image information for left and right eyes, and the image information for the left and right eyes can include image information based on a plurality of view points for one frame of image information. For example, if the image information for the left eye has image information based on two view points, the image information can include odd-numbered image information and even-numbered image information. Likewise, if the information for the right eye has image information based on two view points, the image information can include odd-numbered image information and even-numbered image information. Adjacent odd-numbered images for the right eye and odd-numbered images for the left eye and adjacent even-numbered images for the right eye and even-numbered images for the left eye are combined to form one frame image. The display element 20 can be an LCD, a ferro liquid crystal display (FLCD), or a movable mirror device. The LCD or the FLCD is a polarization-dependent display, and the movable mirror device is a display using unpolarized light.

For example, the display element 20 can be a transmissive LCD, and the light source 15 can be a backlight. The LCD includes thin film transistors (TFTs) and electrodes in a pixel unit, and displays an image by applying an electric field to a liquid crystal layer.

The image separation unit 25 separates an image L and an image R. The image L is based on the image information for the left eye and is directed towards a left eye (LE) of an observer. The image R is based on the image information for the right eye and is directed towards a right eye (RE) of an observer. The image separation unit 25 can be, for example, a lenticular lens, a fly-eye lens array, or a parallax-barrier. Alternatively, the image separation unit 25 can be an LC barrier capable of switching between a 2-D image and a 3-D image. FIG. 2 illustrates an exemplary lenticular lens used as the image separation unit 25.

The polarization conversion switch 30 can be, for example, a liquid crystal polarization conversion switch, and selectively applies power to switch the polarization direction of incident light. For example, if incident light has a P polarization, the polarization conversion switch 30 can switch the P polarization of the incident light into an S polarization. In contrast, if the incident light has an S polarization, the polarization conversion switch 30 can switch the S polarization of the incident light into a P polarization.

The birefringence element 35 has a property such that its refractive index is different depending on the polarization direction of incident light. That is, a normal light ray, having a polarization direction parallel with a crystal optical axis of the birefringence element, is transmitted in a straight line, according to a normal refractive index of the birefringence element, and an abnormal light ray, having a polarization direction perpendicular to the crystal optical axis of the birefringence element, is refracted according to an abnormal refractive index of the birefringence element. Therefore, when light of P polarization and light of S polarization pass through the birefringence element 35, the light is refracted at different angles due to their different polarization. The birefringence element can be made of calcite or nematic liquid crystal.

An image emitted from the display element 20 may have a first polarization direction, e.g., a P polarization. In operation, when the image L for the left eye and the image R for the right eye pass through the image separation unit 25, the images are separated and directed toward regions that correspond to the left and right eyes, respectively. Then, the separated images L and R are incident on the birefringence element 35 through the polarization conversion switch 30. If the polarization conversion switch 30 is in an off-state, the light having a first polarization direction is transmitted without switching the polarization direction. If the first polarization direction is a polarization direction parallel with the crystal optical axis of the birefringence element, the light of the first polarization direction passes through the birefringence element 35. For example, light of P polarization passes through the birefringence element in a straight line, and light of S polarization is refracted when passing through the birefringence element 35.

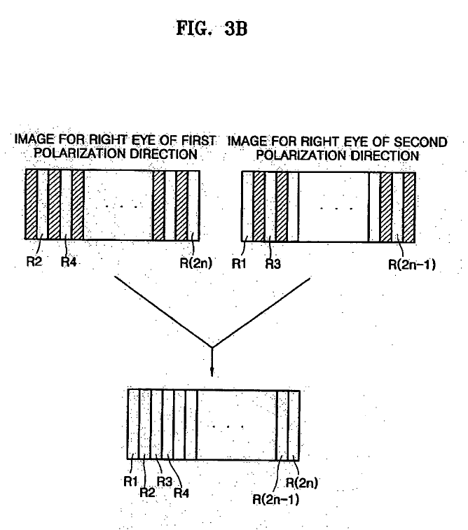

Referring to FIG. 3A, first images L1, L3, L5, . . . , L(2n-1) for the left eye, having the first polarization direction, are formed. Here, n is a natural number. Next, if the image for the left eye having the first polarization direction, processed using the same image information for the left eye, is incident to the polarization conversion switch 25, the polarization conversion switch 25 becomes an on-state to switch the polarization direction. The image L, whose first polarization direction has been switched into a second polarization direction by the polarization conversion switch 25, is incident to the birefringence element 35. The image L, having the second polarization direction, e.g., an S polarization, has a polarization direction perpendicular to the crystal optical axis of the birefringence element 35 and is refracted to a direction different from the light of the first polarization. Therefore, the image based on the same image information for the left eye is shifted according to the polarization direction. That is, referring to FIG. 3A, second images L2, L4, . . . , L(2n) for the left eye, having the second polarization direction, are formed; and the second images, having the second polarization direction, are shifted by a predetermined interval relative to the first images.

The on-off operation of the polarization conversion switch 25 operates in synchronization with an image signal of the display element 20, thereby operating at a frequency that is the same frequency as the image signal of the display element 20. For example, if an image signal processing speed of the display element 20 is 60 Hz, the on-off operation of the polarization conversion switch 25 operates in units of 1/60 sec. That is, the polarization conversion switch 25 performs a one-time on-off operation for each image signal from the display element 20, and thus an image of the first polarization direction and an image of the second polarization direction are sequentially output in a set for each image signal.

If the polarization conversion switch 25 is in the off-state, images based on image signals of the display element 20 pass through the birefringence element 35 without change in their polarization direction to form the first images. In contrast, if the polarization conversion switch 25 is in the on-state, the images based on image signals of the display element 20 are switched in their polarization direction, are incident to the birefringence element 35, and are refracted by the birefringence element 35 to form the second images, which are shifted relative to the first images. The first and second images are then combined to form one frame image, and thus the resolution of a 3-D image is improved.

FIG. 3B is a view illustrating a process by which the image R of the first polarization direction and the image R of the second polarization direction are combined to form one frame image for the right eye. Since the process is the same as the above-described process of forming the image L for the left eye, detailed description thereof will be omitted.

Consequently, the image L of the first polarization direction and the image L of the second polarization direction are combined to form one frame image for the left eye. Similarly, the image R of the first polarization direction and the image R of the second polarization direction are combined to form one frame image for the right eye.

According to the present general inventive concept, the resolution of a 3-D image is improved by shifting the images using interaction between the polarization conversion switch and the birefringence element.

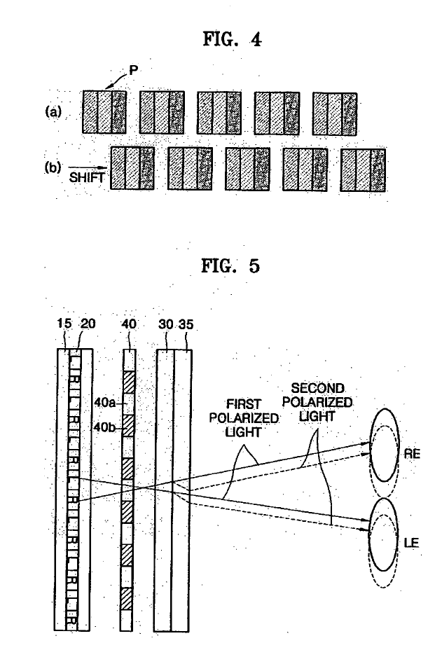

FIG. 4 illustrates in more detail an image formation process for a pixel unit p. Assuming that FIG. 4A illustrates the first image of the first polarization direction and FIG. 4B illustrates the second image of the second polarization direction, the second image of the second polarization direction is shifted relative to the first image of the first polarization direction. As described above, the first and second images form one frame and the second image is shifted relative to the first image, whereby a color separation phenomenon produced between pixels is prevented, as illustrated in FIG. 4. The gaps between pixel images of the first image of the first polarization direction are filled by pixel images of the second image of the second polarization direction.

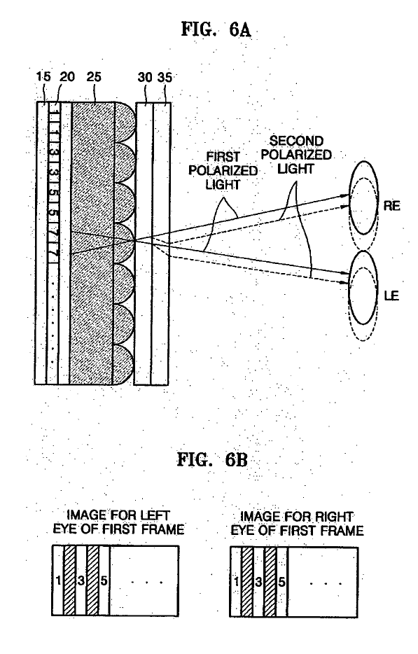

FIG. 5 is a view illustrating a construction of a 3-D image display device according to another embodiment of the present general inventive concept. The image display device of FIG. 5 is different from that of FIG. 2 in that a parallax-barrier 40 is adopted as the image separation unit while the other components are the same.

The parallax-barrier 40 includes slits 40a and barriers 40b formed in an alternate manner. An image is transmitted through the slits 40a and is blocked off by the barrier 40b, so that images from the display element 20 are divided into images for a right eye and images for a left eye. Next, since a process, in which the image R and the image L are processed by the polarization conversion switch 30 and the birefringence element 35 according to their polarization direction and combined to form the image, is the same as the principle described with reference to FIG. 2, a detailed description thereof will be omitted.

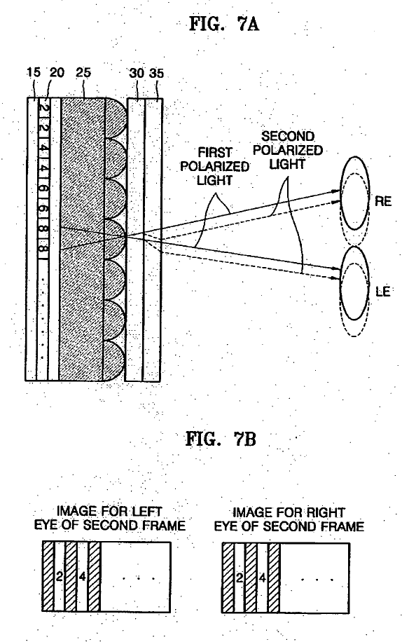

The 3-D image display devices according to embodiments of the present general inventive concept can also be switched into a 2-D mode. Referring to FIG. 6A, to display an image in two dimensions, the same image signal is used for a left eye image and for a right eye image, to form a first frame for the first polarization. Referring to FIG. 6B, the same image is displayed on the left eye and the right eye so that a 2-D image is realized. Further, the polarization conversion switch 30 operates to switch the polarization direction from the first polarization into the second polarization, and converts an image signal into an image signal for the second polarization. The same image signal for the second polarization is provided to the left eye and the right eye, respectively, as illustrated in FIG. 7A. A second frame for the second polarization is formed to realize a 2-D image as illustrated in FIG. 7B. Through such a process, the first and second frames form one set, to realize a 2-D image without deterioration in resolution.

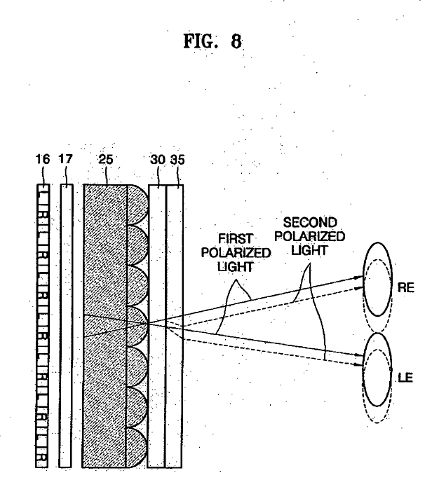

FIG. 8 illustrates an exemplary movable mirror device 16 being used as a display element. The movable mirror device 16 includes a plurality of micro-mirrors arranged 2-dimensionally. The micro-mirrors can rotate independently. An incident beam propagates toward a projection lens unit or deviates from the projection lens unit, depending on the rotational direction of the micro-mirror. Consequently, the micro-mirror is on/off-operated by pixel unit, so that an image is realized. When an image is formed using the movable mirror device 16, since unpolarized light is used, a polarization converter 17 is provided between the movable mirror device 16 and the image separation unit 25 in order to convert light from the movable mirror device 16 into light having one polarization direction. The polarization converter 17 converts incident light into light of P polarization, which is divided into an image for a left eye and an image for a right eye by the image separation unit 25. Further, when the polarization conversion switch 30 is in an off-state, the light of the P polarization passes through the polarization conversion switch 30 and the birefringence element 35 without refraction to form the image for the left eye and the image for the right eye. Subsequently, when the polarization conversion switch is in an on-state, the light of the P polarization is converted into light of the S polarization, and the light of the S polarization is refracted by the birefringence element 35. Through such a process, an image of the S polarization is displayed shifted relative to an image of the P polarization, so that the resolution of a 3-D image is not deteriorated.

As described above, in an image display device, an image for one image signal is shifted, and images at a plurality of viewpoints may be provided by a polarization conversion switch and a birefringence element, so that resolution is improved. Using the embodiments described above it is possible to form one frame image using images corresponding to three or more view points. The images at the plurality of view points are sequentially shifted using the polarization conversion switch and the birefringence element, and image signals that correspond to the images at the plurality of view points are sequentially moved.

The image display device sequentially switches the polarization direction of the incident light using the polarization conversion switch and shifts the image, whose polarization direction has been switched, using the birefringence element, thereby improving the resolution of the 3-D image. Further, in the embodiments of the present general inventive concept, a color separation phenomenon produced when realizing the 3-D image can be prevented.

Moreover, a 2-D image can be realized by providing the same images for the left eye and the right eye, so that the 2-D image or the 3-D image can be selectively displayed.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A 3-D (dimension) image display device comprising:
a display element to emit light according to image information for a left eye and image information for a right eye;
an image separation unit to separate the emitted light into a left image and a right image corresponding to the image information for the left eye and the image information for the right eye;
a polarization conversion switch to sequentially switch a polarization direction of the light; and
a birefringence element to transmit or to refract the light, depending on the polarization direction of the light that has passed through the polarization conversion switch, shifting the light whose polarization direction has been switched by the polarization conversion switch.

2. The device of claim 1, wherein the birefringence element comprises a calcite or nematic liquid crystal.

3. The device of claim 1, wherein the image separation unit is a lenticular lens, a fly-eye lens array, or a parallax barrier.

4. The device of claim 1, wherein the display element is an LC (liquid crystal) panel.

5. The device of claim 1, wherein the polarization conversion switch is a liquid crystal polarization conversion switch.

6. The device of claim 1, wherein the polarization conversion switch operates with a frequency substantially the same as a frequency of an image signal supplied to the display element.

7. The device of claim 1, wherein the display element is a movable mirror device and comprises a polarization converter to convert emitted light into light of one of P polarization and S polarization, the polarization converter being disposed between the display element and the image separation unit, or between the image separation unit and the polarization conversion switch.

8. The device of claim 1, wherein the image information for the left eye is substantially the same as the image information for the right eye to form a 2-D (2-dimensional) image.

9. A display device to form a first image at a first location and a second image at a second location, the device comprising:
a display element to emit polarized light according to an input image signal;
an image separation unit to direct the emitted light to form the first image at the first location and the second image at the second location;
a polarization conversion switch having an on-state to switch a polarization direction of the light passing therethrough and an off-state to leave the polarization direction of the light passing unchanged; and
a shifting element to transmit the light at different angles depending on the polarization direction of the light.

10. The device of claim 9, wherein the display element is a liquid crystal display or a ferro liquid crystal display.

11. The device of claim 9, wherein the display element comprises:
a movable mirror including a plurality of micro-mirrors arranged 2-dimensionally; and
a polarization converter to convert the unpolarized light received from the mirror into polarized light.

12. The device of claim 9, wherein the image separation unit is one of a lenticular lens, a fly-eye array, and a parallax-barrier.

13. The device of claim 9, wherein the first image at the first location is substantially the same as the second image at the second location.

14. The device of claim 9, wherein the input image signal updates with a predetermined frequency.

15. The device of claim 14, wherein the polarization conversion switch cycles between the on-state and off-state at the predetermined frequency.

16. A method of forming a first image at a first location and a second image a second location, the method comprising:
emitting polarized light according to an input image signal;
directing the emitted light to form the first image at the first location and the second image at the second location;
sequentially switching a polarization direction of the light; and
shifting the light at different angles depending on the polarization direction.

17. The method of claim 16, wherein the emitting of the polarized light according to the input image signal further comprises:
emitting polarized light towards a display panel; and
transmitting the polarized light through the display panel according to applied electric fields on a 2-D array of electrodes on the display panel, the electric fields being applied based on an input image signal.

18. The method of claim 16, wherein the emitting polarized light according to the input image signal comprises:
reflecting unpolarized light by a 2-D array of mirrors oriented according to the input image signal; and
converting the unpolarized light incoming from the 2-D array of mirrors into the emitted polarized light.
